(19) United States
(12) Patent Application Publication
(10) Pub. No.: US 2015/0052420 A1
(43) Pub. Date: Feb. 19, 2015

(54) METHODS AND DEVICES FOR ACCESSING AND DISPLAYING CONTENT ON A MOBILE DEVICE

(71) Applicant: TECH 2000, INCORPORATED, Herndon, VA (US)

(72) Inventors: George H. CHURCHWELL, Herndon, VA (US); Howard COHEN, Oakland, CA (US)

(21) Appl. No.: 14/474,061

(22) Filed: Aug. 29, 2014

Related U.S. Application Data
(63) Continuation of application No. PCT/US2014/048097, filed on Jul. 25, 2014.
(60) Provisional application No. 61/858,786, filed on Jul. 26, 2013.

(30) Foreign Application Priority Data
Jul. 25, 2014 (US) PCT/US2014/048097

(51) Int. Cl. G06F 17/22; H04L 29/08; G09B 5/00; G06F 17/30

(52) U.S. Cl. CPC G06F 17/2235; G06F 17/2247; G06F 17/30896; H04L 67/1095; G09B 5/00
USPC 715/205

(57) ABSTRACT

The present invention relates, for example, to a software application (“app”), such as for, e.g., the iPad™ or iPhone™, that allows HTML, for example HTML5, control of a mobile device user experience, for example, in an iOS operating system and display screen through an HTML, for example HTML5, Application Programming Interface (API) that controls a cloud server to implement push managed content. The present invention also relates to HTML control of the user experience in other mobile devices, for example an Android operating system.

### CROSS-REFERENCE TO RELATED APPLICATIONS

This application is a continuation of International Application No. PCT/US2014/048097, filed Jul. 25, 2014, which designated the U.S. and claims priority to U.S. provisional patent application 61/858,786 filed Jul. 26, 2013, which are hereby incorporated in their entirety including all tables, figures, and claims.

### BACKGROUND OF THE INVENTION

The present invention relates, for example, to a software application (“app”), such as for, e.g., the iPad™ or iPhone™, that allows HTML, for example HTML5, control of a mobile device user experience, for example, in an iOS operating system and display screen through an HTML, for example HTML5, Application Programming Interface (API) that controls a cloud server to implement push managed content. The present invention also relates to HTML control of the user experience in other mobile devices, for example an Android operating system.

Educational content and the user environment are costly and difficult to modify in an iOS™ app. This reduces the ability to make marketing changes. It is difficult to make Multimedia Course content available in push protected mode for paying students.

No other App available allows a low-cost HTML programmer to control an educational environment via iOS™ for off-line use. Most education solutions require changes to be made in iOS item and display it via a viewer.

For iOS™ changes to be seen they typically have to be coded by a costly resource and then require the user to “update” the app which is not typically done. Tech 2000's app uses an iOS “Kernel” code resident on the iPad that allows content in the app to be easily encrypted and pushed to a client for local caching and entitlement control for access.

As can be seen, there is a need for solutions to these and other problems.

### BRIEF DESCRIPTION OF THE DRAWINGS

FIG. 1 is a schematic view of one embodiment of the present invention.

FIG. 2 is a schematic view of one embodiment of the present invention.

FIG. 3 is a screenshot view of one embodiment of the present invention.

FIG. 4 is a flow chart of embodiments of the present invention.

FIG. 5 is a schematic diagram of embodiments of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The app according to one embodiment of the present invention allows very low cost and rapid modification of the user environment, as well as effective offline use. In addition it makes it very easy for a user with commerce-based content to selectively allow access to the content on a device-by-device basis.

The app according to one embodiment of the present invention allows rapid changes of customer facing content, typically for education, via HTML, e.g. HTML5, versus iOS™ programming. In addition the HTML, e.g. HTML5, is “codehook” (the term “link” is also used herein to refer to a codehook) integrated with an API to call content, thereby allowing a low cost way to manage the users' environment. All content is available via codehooks within HTML and then the user is authenticated, authorized and accounted for on each access. In an embodiment, the codehook or link is resolved by the API or by the app, points to content contained in the memory of the mobile device and does not point to a URL.

The app according to one embodiment of the present invention allows a low cost HTML programmer to control the visual environment while still having access to iOS™ properties. The app pushes display updates without an iOS™ update. The app allows entitlement control by the teacher in a classroom.

Referring now to the drawings, the app according to one embodiment of the present invention may include several elements

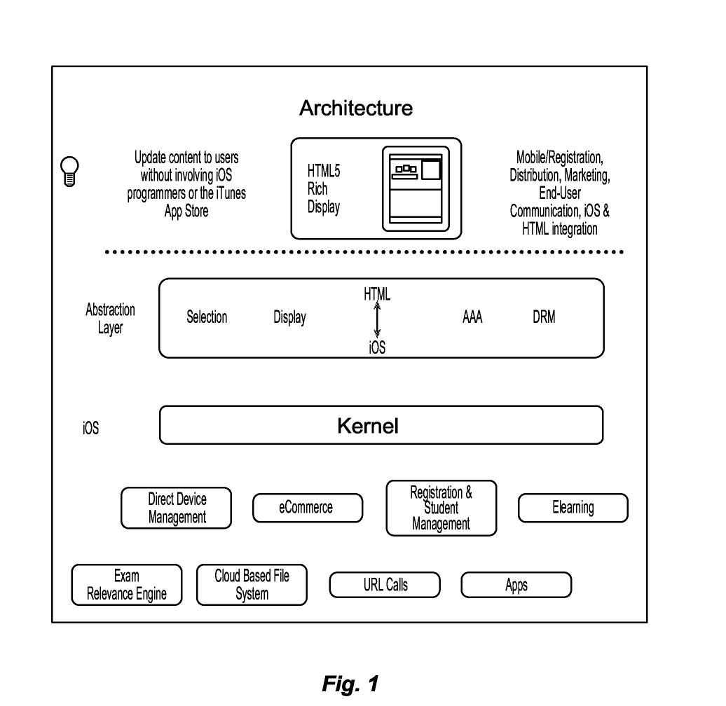

Referring to the embodiments shown in FIG. 1:

1. HTML, e.g. HTML5, Display—Provides the user interface to content via HTML, e.g. HTML5. The displays may be synchronized to a cloud server and may update based on changes to the cloud version of the HTML. The HTML interface provides access to iOS™ content , locally cached, via “codehooks.”

2. Abstraction Layer—This layer provides the integration between HTML URL calls, and iOS™ API elements and content, known as “codehooks.” This layer may also enforce the entitlement security for authorization, authentication and accounting. As used in the FIG. 1, AAA refers to authentication authorization accounting and DRM refers to Digital Rights Management protection.

3. Kernel—This layer provides the core iOS™ function which does not need to change in order to change the views for the iPad™ user. This layer manages all security and content management functions, including decryption and local storage.

An additional layer in an additional embodiment is a Managed Services layer. This layer depicts, for example, all, of the external content functions which are loaded into the Cloud Services for viewing on the mobile iPad™. The layer may interact with the user like an FTP server and downloads the content to the mobile device when selected. In addition this layer can be used to pre-process the content items, e.g., encrypt, change format from PDF to PNG, etc.

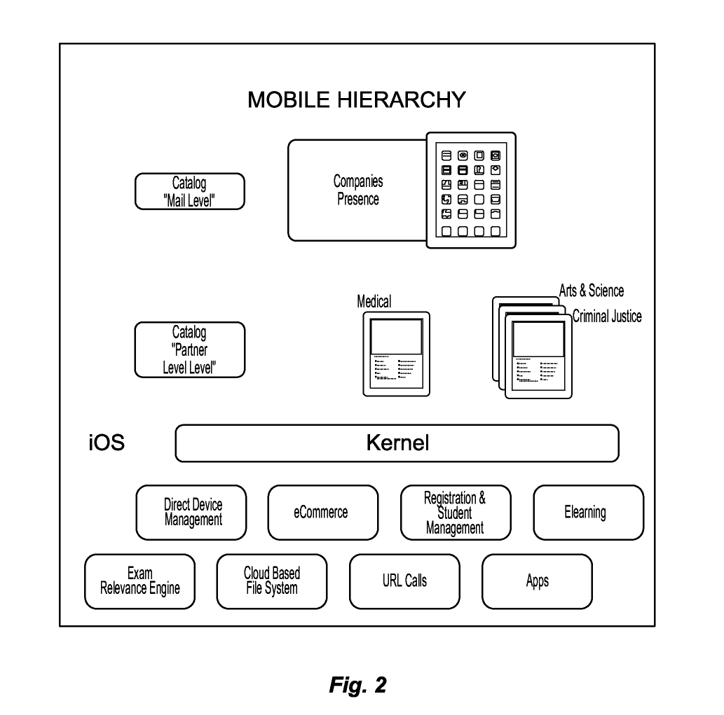

Referring to FIG. 2., an embodiment is shown where HTML displays on mobile devices are arranged in multiple hierarchies, each display being a separate hierarchy. In an embodiment, the app contains one or more administrator hierarchies and each customer provides one or more additional hierarchies each hierarchy containing codehooks referring to specific content.

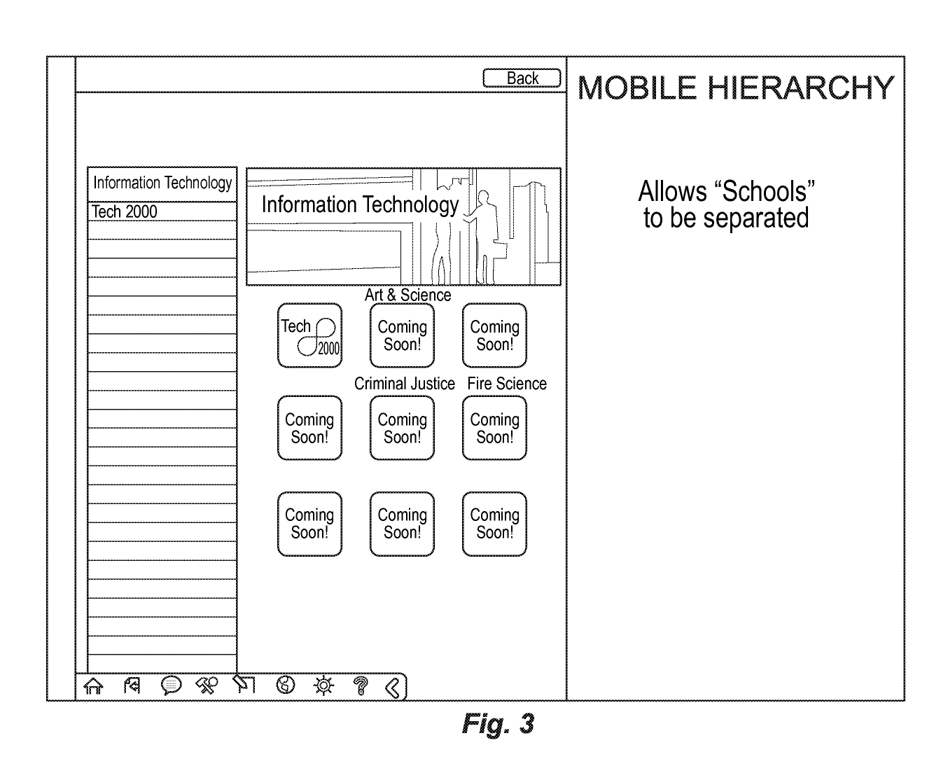

Referring to FIG. 3, an embodiment is shown where HTML display hierarchies provide for the content of different schools to be separately or individually shown on a mobile device.

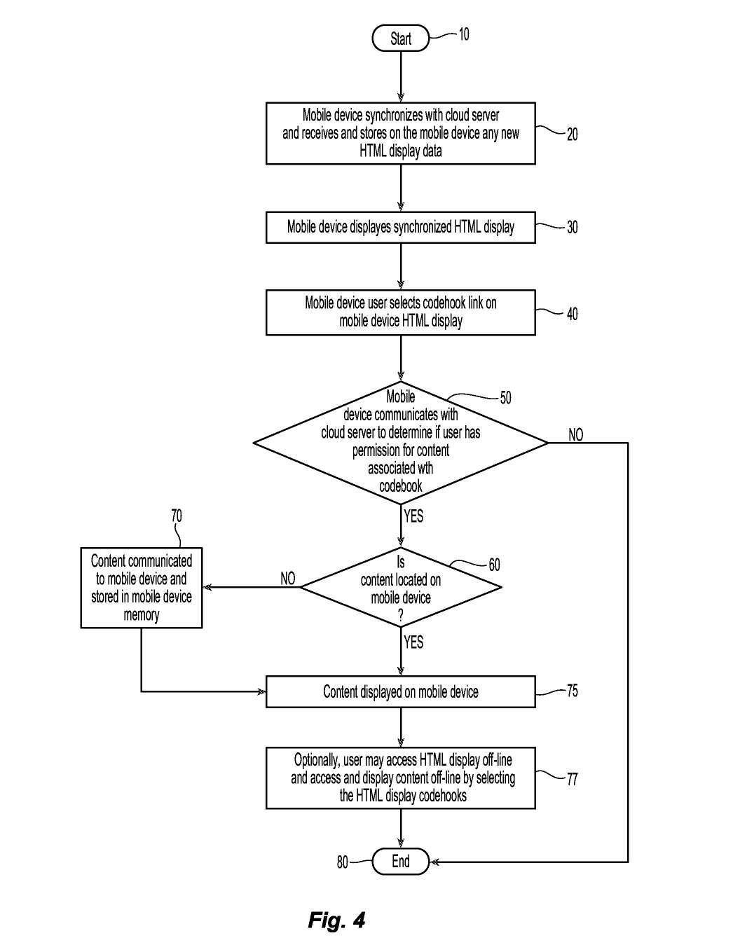

Referring to FIG. 4, a flow chart is shown of additional embodiments of processes of the present invention. The process begins at process start 10 and ends at process end 80. A mobile device synchronies with a cloud server and receives and stores in the memory of the mobile device the HTML display data 20. This permits multiple individual customers, for example, thousands or even millions of customers, to each customize for tens, hundreds, thousands or millions of specific mobile device users or groups of users individual interfaces by providing new or updated HTML display data to the cloud server and avoids designing thousands or millions of different apps for each individual user or set of users. Furthermore, in another aspect of the invention (not shown in FIG. 4) the mobile device initially communicates with the cloud server to determine the specific individualized HTML display that is designated for the individual user (or group of users) so that each mobile device user sees a realtime individualized display. Furthermore, the synchronization step of the process 20 further permits a customer to provide customizations to the display designated for a mobile device user without having to design and require download by the user of a new app version each time a customization is desired.

Next, the mobile device displays the synchronized HTML display 30. Then a mobile device user selects a codehook link on the mobile device HTML display 40. The mobile device then communicates with the cloud server to determine if the user has permission for the content associated with the codehook link 50. If no, the process proceeds to process end 80 and optionally the user may be asked for authentication, e.g., a password. If the user does have permission for the content associated with the codehook, it is then determined if the content is located in the memory of the mobile device 60.

If the content is already located in the memory of the mobile device, then the content is displayed on the mobile device 75. If the content has been encrypted, then the content is decrypted prior to display 75. If the content is not already located in the memory of the mobile device, then the content is received from the cloud server and stored in the mobile device memory 70. This storage of content on the mobile device allows self-contained offline usage of the app. The content stored in the memory of the mobile device is optionally encrypted. Such stored content is then displayed on the mobile device 75. Furthermore, the user may access the HTML display off-line by selecting the codehooks in the HTML display during off-line use 77. Such off-line selection will access and display the content stored on the memory of the mobile device thereby providing the user with complete off-line use of the HTML display to select and access content. In an embodiment, the API and the app are configured to use will and have delegate functions to (1) recognize, during either on-line or off-line use, that a codehook is not a URL and instead is associated with a content file, e.g., a text (for example, PDF), picture or video file, and (2) access and display, during either on-line or off-line use, the content using the appropriate display programs located on the device.

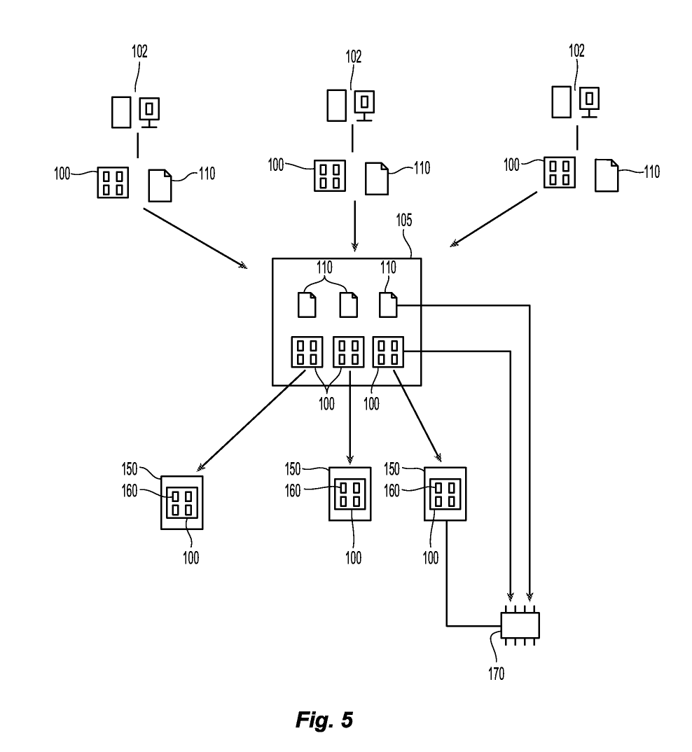

Referring to FIG. 5, shown is a schematic of additional embodiments of the current invention. In this schematic, individual customers provide, e.g., wirelessly communicate, via computing devices 102, HTML display data files 100 and content files 110 to a cloud server 105. The HTML data files 100 may be communicated in zip archive files and stored as such on the cloud server 105, the files being which by the user mobile device 150. Furthermore, the HTML display data files may contain various forms of display data, e.g., images, directories, selection sheets, etc.

The computing devices 102, may be desktop computers, mobile devices or other computing devices. The HTML display data files 100 shown on the user mobile device 150, as discussed elsewhere herein, may be modified or replaced by the customer by providing new or revised HTML display data to the cloud server 105. For representation purposes, only three computing devices 102 (indicating different customers) and three HTML display data files 100 and content files 110 are shown. In practice, thousands or millions of different customers may each provide tens, hundreds or thousands of different HTML display data files 100 to the cloud server 105 and may each provide to the cloud server 105 tens, hundreds, thousands or millions of specific content items 110, with each such content being uniquely configured so that it may be individually and specifically referenced by a codehook 160 contained in an HTML display 100 on a user device 150.

As further shown in FIG. 5, the HTML display data 100 is communicated by the cloud server 105 to user mobile devices 150, which are for example iPads, but may be other forms of mobile devices, e.g. iPhones, tablets, etc. As additionally shown in FIG. 5, the HTML display data 100 is displayed on the mobile device 150. Also shown in FIG. 5 is the communication and storage of content files 110 and HTML display data files 100 in the memory device 170 of the mobile device 150, for example a flash memory device. This storage permits self-contained off-line usage of the app to display content.

In a further embodiment, the iPad™ app is downloaded from the Apple App™ store. Once downloaded, the app contacts the cloud server and the initial HTML, e.g. HTML5, display is downloaded. The user can then select any “codehook” that was embedded in the HTML, e.g. HTML5, code. The selection will initialize authentication check on the cloud server and either allow the access or query the server manager to grant access.

Once access is granted the content may be sent to the iPad™ for local storage and distribution. The content may be time stamped and assigned an ID. Each time in the future that the iPad™ is activated the ID may be checked against the cloud server for a time stamp; if the content on the cloud server is newer than the content on the iPad™, the content is updated.

This product could be made by loading the Apple™ development environment, then writing code to map URL calls in HTML to iOS™ assets, such as, movies, documents, images or HTML files. Once this is done the HTML, e.g. HTML5, elements may be mapped into a display. The present app may then need to synchronize the display on the iPad™ with the copy in the cloud server. Once this is synchronized using a GMT clock, files that are synchronized can also be downloaded.

HTML, e.g. HTML5, URL calls to iOS™ “codehooks” are important to the functionality of the present app. Synchronization of HTML pages and code-hooked content via GMT time may be necessary. Various content type, such as PDF, MP4, etc., and encryption are optional elements. The present app may also support a Notes feature on PDF files that allows students to take notes that can be selectively called at a later time.

For example in an Android mobile device operating system, the addition of links to local apps such as Powerpoint™, Keynote™, Word™ and others for execution of content being displayed may be employed. It is possible to offer the file management and GMT sync for local file caching and updating without the HTML, e.g. HTML5, page control.

This product may be designed to support Mobile Content Management in an educational environment. A teacher could create an HTML page with all of the content needed for a student to learn, including text-PDF, video, URL links, and assessments in a rich HTML display format. The teacher can then very easily update content as needed.

Alternatively, instead of an educational role, the application could be used to manage content for an association. The association could post all of its meeting notes to members in a rich HTML display, for example.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

Further embodiments include:

A method for accessing content on a mobile device, comprising: determining if new or additional HTML display data is available on a cloud server, and if so, receiving and storing the new or additional HTML display data from the cloud server in the memory of the mobile device, displaying on the mobile device the new or additional HTML display data, and accessing and displaying content on the mobile device by selecting a link contained in the HTML display, wherein the link references and causes to be displayed specific content stored in the memory of the mobile device, or, if the content is not stored in the memory of the mobile device, then selecting the link causes the content to be communicated to and stored in the memory of the mobile device prior to the content being accessed and displayed.

The above method, wherein the content is multimedia content.

The above method, wherein the content is multimedia educational content.

The above method, wherein the mobile device operating system is an iOS operating system and the HTML display data is in an HTML5 format.

The above method, wherein the mobile device in an iPad.

The above method, wherein the HTML display data received by the mobile device is stored on the memory of the mobile device in an encrypted form available to the user for off-line use.

The above method, wherein changes to the HTML display on the mobile device are made by receiving wirelessly on the mobile device updated or new HTML display data from the cloud server, wherein the updated HTML display data has been added to the cloud server by a third party customer.

The above method, wherein the link references a unique item of content stored on the cloud server.

The above method of claim, wherein the content is only displayed on the mobile device if an application on the mobile device is granted permission by the remote server to display the content and wherein the content contained in the memory of the mobile device is encrypted.

The above method, wherein
the content is multimedia content,
the mobile device is an iPad operating on an iOS operating system,
the HTML display data is in an HTML5 format,
the link references a unique item of content stored on the cloud server, which unique content is received wirelessly by the mobile device from the cloud server and is stored in the memory of the mobile device in an encrypted form accessible to the user for off-line use, and
changes to the HTML display on the mobile device are made by receiving wirelessly on the mobile device updated or new HTML display data from the cloud server, wherein the updated HTML display data has been added to the cloud server by a third party customer.

Further embodiments include mobile university displays in which students can access content on and off-line, real-time tracking of mobile users is provided as is rapid deployment.

Further embodiments provide cloud based mobile content management, HTML simple control of the user experience, leading edge educational capability, mobile tracking and access control through entitlements. Additional embodiments provide opportunities in commerce/are commerce capable, e.g., if a user is denied access to content, the app can provide a passcode to the user, upon payment of a fee, to permit access to specific content. Furthermore, the implied interest of a user can be assessed based on a user's selection of specific content or pattern of selection of content and this information can be used to provide the user with an opportunity to purchase this content or to advise a customer of the user's selection or pattern of selection.

It should be understood, of course, that the foregoing relates to exemplary embodiments of the invention and that modifications may be made without departing from the spirit and scope of the invention.

What is claimed is:

1. A method for accessing content on a mobile device, comprising:
determining if new or additional HTML display data is available on a cloud server, and if so, receiving and storing the new or additional HTML display data from the cloud server in the memory of the mobile device,
displaying on the mobile device the new or additional HTML display data, and
accessing and displaying content on the mobile device by selecting a link contained in the HTML display, wherein the link references and causes to be displayed specific content stored in the memory of the mobile device, or, if the content is not stored in the memory of the mobile device, then selecting the link causes the content to be communicated to and stored in the memory of the mobile device prior to the content being accessed and displayed and wherein once content is downloaded, the HTML display and the links are configured to operate off-line permitting off-line accessing of content on the mobile device by a user by selecting the links in the HTML display.

2. The method of claim 1, wherein the content is multimedia content.

3. The method of claim 1, wherein the content is multimedia educational content.

4. The method of claim 1, wherein the mobile device operating system is an iOS operating system and the HTML display data is in an HTML5 format.

5. The method of claim 1, wherein the mobile device in an iPad.

6. The method of claim 1, wherein the HTML display data received by the mobile device is stored on the memory of the mobile device in an encrypted form.

7. The method of claim 1, wherein changes to the HTML display on the mobile device are made by receiving wirelessly on the mobile device updated or new HTML display data from the cloud server, wherein the updated HTML display data has been added to the cloud server by a third party customer.

8. The method of claim 1, wherein the link references a unique item of content stored on the cloud server.

9. The method of claim 1, wherein the content is only displayed on the mobile device if an application on the mobile device is granted permission by the remote server to display the content and wherein the content contained in the memory of the mobile device is encrypted.

10. The method of claim 1, wherein
the content is multimedia content,
the mobile device is an iPad operating on an iOS operating system,
the HTML display data is in an HTML5 format,
the link references a unique item of content stored on the cloud server, which unique content is received wirelessly by the mobile device from the cloud server and is stored in the memory of the mobile device in an encrypted form accessible to the user for off-line use, and
changes to the HTML display on the mobile device are made by receiving wirelessly on the mobile device updated or new HTML display data from the cloud server, wherein the updated HTML display data has been added to the cloud server by a third party customer.
